(19) United States
(12) Patent Application Publication
(10) Pub. No.: US 2008/0024833 A1
(43) Pub. Date: Jan. 31, 2008

(54) FACSIMILE MACHINE

(75) Inventor: Shinji KAWASAKI, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/828,755

(22) Filed: Jul. 26, 2007

(30) Foreign Application Priority Data
Jul. 27, 2006 (JP) 2006-204239

(51) Int. Cl. H04N 1/00; H04N 1/32

(52) U.S. Cl. 358/468; 358/400

(57) ABSTRACT

A facsimile machine includes an entry unit, a searching unit, a transmitting unit and a control unit. The entry unit accepts a transmission instruction including a destination. The searching unit searches the destination information in a database held by an external database device with the destination as a search key. The transmitting unit executes the facsimile transmission. The control unit causes the searching unit to execute searching for the first time immediately after the acceptance of the transmission instruction by the entry unit and for the second time immediately before the facsimile transmission in the case in which the entry unit accepts the time-specified transmission instruction or immediately before the redialing facsimile transmission and, when it is found that the destination information including the search key exists in the database by the searches for the first time and the second time, causes the transmitting unit to execute the facsimile transmission for the corresponding destination.

### CROSS-REFERENCE TO RELATED APPLICATIONS

This application claims priority under 35 U.S.C 119 to Japanese Patent Application No. 2006-204239, filed on Jul. 27, 2006, which application is hereby incorporated by reference in its entirety.

### BACKGROUND OF THE INVENTION

### Field of the Invention

The present invention relates to a facsimile machine and, more specifically, to a facsimile machine including a function to prevent erroneous transmission such as to send a document to a wrong destination by the facsimile machine.

The erroneous transmission such as to send a document to a wrong destination by a facsimile machine not only gives a trouble to the opposite party, but also causes a problem of information leak or the like. Such erroneous transmission is caused by wrong input of the facsimile number through direct entry or change of the facsimile number of the opposite party due to, for example, the relocation thereof.

In the related art, various technologies are proposed for avoiding such wrong transmission. For example, in order to maintain latest correct dial information registered in the facsimile machine, a facsimile machine which accesses database in which the latest correct information is registered periodically to automatically renew the stored dial information is proposed. Accordingly, avoidance of the wrong input of the facsimile number or the erroneous transmission caused by the change of the facsimile number of the destination are intended.

### SUMMARY OF THE INVENTION

However, with the facsimile machine described above, there is a problem such that the erroneous transmission may occur depending on the relation between the automatic renewal and the change of the facsimile number of the opposite party. For example, when the facsimile transmission is executed immediately after the facsimile number of the opposite party is changed, the dial information registered in the facsimile machine is not necessary renewed automatically, the fact that the facsimile transmission is executed to an old facsimile number may occur.

In particular, in the facsimile transmission through the time-specified facsimile transmission or redial transmission, there is a time lag between the timing when the facsimile number of the destination of the transmission is determined, and the timing when the transmission is actually executed. Therefore, even when the dial information is automatically renewed, a long period of time is elapsed from the determination of the destination to the actual transmission and, consequently, the possibility that the facsimile number of the opposite party is changed during this period of time is high (that is, there occurs a period of time which is not automatically renewed), so that the erroneous transmission such as to send a document to the old facsimile number may occur.

In view of such circumstances, it is an object of the present invention to provide a facsimile machine which can achieve facsimile transmission to a correct destination without causing erroneous transmission even in the case of time-specified transmission or redial transmission.

In order to achieve the above-described object, a facsimile machine according to the present invention includes a connecting unit, an entry unit, a searching unit, a transmitting unit and a control unit. An external database device is connected to the connecting unit via communication networks. The entry unit accepts transmission instruction including the destination of facsimile transmission. The searching unit searches the destination information in the database held by the database device with the destination accepted by the entry unit as a search key. The transmitting unit executes the facsimile transmission. The control unit causes the searching unit to execute search for the first time immediately after the acceptance of the transmission instruction by the entry unit and for the second time immediately before the facsimile transmission in the case in which the entry unit accepts the time-specified transmission instruction and, when it is found that the destination information including the search key exists in the database by the searches for the first time and the second time, causes the transmitting unit to execute the facsimile transmission for the corresponding destination.

Accordingly, since the fact that the destination exists in the latest database is confirmed not only at the time of the transmission instruction, but also immediately before the time-specified facsimile transmission, the erroneous facsimile transmission caused by the change of the facsimile number during that time is avoided.

In order to achieve the above-described object, a facsimile machine according to the present invention includes a connecting unit, an entry unit, a searching unit, a transmitting unit and a control unit. An external database device is connected via the connecting unit and communication networks. The entry unit accepts transmission instruction including the destination of facsimile transmission. The searching unit searches the destination information in the database held by the database device with the destination accepted by the entry unit as a search key. The transmitting unit executes the facsimile transmission. The control unit causes the searching unit to execute search for the first time immediately after the acceptance of the transmission instruction by the entry unit and for the second time immediately before redialing facsimile transmission and, when it is found that the destination information including the search key exists in the database by the searches for the first time and the second time, causes the transmitting unit to execute the facsimile transmission for the corresponding destination.

Accordingly, since the fact that the destination exists in the latest database is confirmed not only at the time of the transmission instruction, but also immediately before the redialing facsimile transmission, the erroneous facsimile transmission caused by the change of the facsimile number during that time is avoided.

It is also possible to configure in such a manner that the control unit further determines whether or not the time period from the acceptance of the transmission instruction by the entry unit until the time-specified facsimile transmission is executed by the transmitting unit is longer than a predetermined time period and, if not, causes the transmitting unit to execute the time-specified facsimile transmission or the redialing facsimile transmission without causing the search for the second time to be executed.

For example, the control unit determines whether or not the date that the entry unit accepts the transmission instruction matches the date when the transmitting unit executes the time-specified facsimile transmission or the redialing facsimile transmission and, if yes, causes the transmitting unit to execute the time-specified facsimile transmission or the redialing facsimile transmission without executing the search for the second time.

Accordingly, when the database is renewed only once in a day, occurrence of unprofitable communication load and processing time due to duplicate execution of the destination confirmation at the time of transmission instruction and at the time of transmission is avoided.

Preferably, the entry unit further accepts an instruction indicating whether or not the destination is to be collated with the database and, when the entry unit accepts the instruction not to collate the destination and the database, the control unit causes the transmitting unit to execute the time-specified facsimile transmission or the redialing facsimile transmission without executing the searches for the first time and the second time.

Accordingly, whether or not the destination confirmation is to be executed may be selected, and one of the prevention of the erroneous transmission and speed-up of the transmission processing by omitting the destination confirmation may be given priority, so that various operating methods may be accommodated.

According to the present invention, the facsimile transmission to the correct destination is achieved without erroneous transmission even in the case of the time-specified or redialing facsimile transmission.

Therefore, giving a trouble to other persons by the erroneous facsimile transmission and leak of information may be reliably prevented, so that the practical value of the present invention is extremely high.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a drawing illustrating a configuration of a communication system including a facsimile machine according to the present invention.

FIG. 2 is a drawing illustrating a configuration of the latest database held in a Lightweight Directory Access Protocol (LDAP) server.

FIG. 3 is a drawing illustrating a hardware configuration of the facsimile machine.

FIG. 4 is a drawing illustrating a configuration of a management table placed in a transmission queue held by the facsimile machine.

FIG. 5 is a block diagram illustrating a configuration of a characteristic function of the facsimile machine.

FIG. 6 is a flowchart showing a procedure of processing of the facsimile machine when an operator issues an instruction of a facsimile transmission.

FIG. 7 is a drawing explaining the processing shown in the flowchart in FIG. 6.

FIG. 8 is a drawing explaining the processing shown in the flowchart in FIG. 6.

FIG. 9 is a drawing explaining the processing shown in the flowchart in FIG. 8.

### DETAILED DESCRIPTION OF PREFERRED EMBODIMENTS

An optimal example for implementing the present invention will be described below.

### Example

Referring now to the drawings, an embodiment of the present invention will be described in detail.

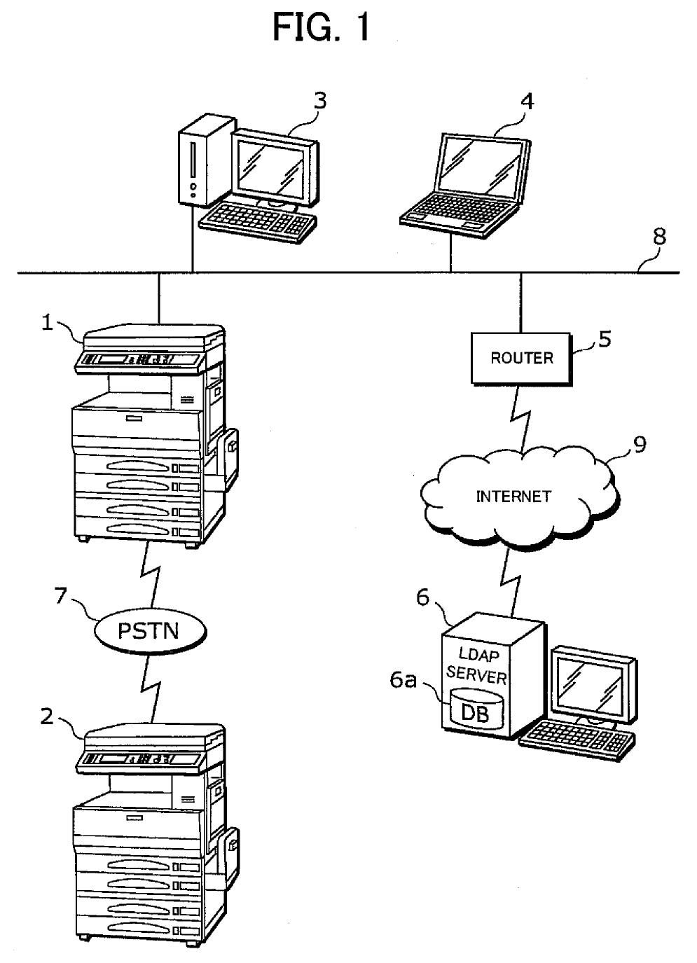

FIG. 1 is a drawing illustrating a configuration of a communication system including a facsimile machine according to the present invention. In this communication system, a facsimile machine 1 according to the present invention is connected to an opposite facsimile machine 2, which corresponds to the opposite party of the facsimile transmission, via Public Switched Telephone Networks (PSTM) 7, and is connected to terminal devices 3 and 4, and a router 5 via a Local Area Network (LAN) 8. In addition, the facsimile machine 1 is also connected to a Lightweight Directory Access Protocol (LDAP) server 6 via the LAN 8, the router 5 and an internet 9.

The terminal devices 3 and 4 are terminal devices that serves as a Web client and accesses the facsimile machine 1 as a Web sever via the LAN 8, give various instructions to the facsimile machine 1, and set various parameters, and function also as remote operation panels of the facsimile machine 1.

The router 5 is a router that functions as a gateway for mutually connecting the LAN 8 and the internet 9 as a Wide Area Network (WAN).

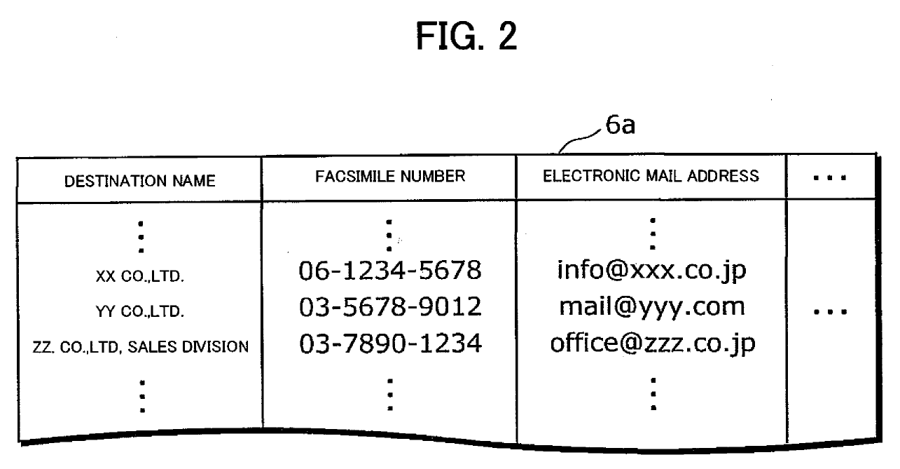

The LDAP server 6 is a device that provides a directory service using a protocol referred to as LDAP, and is an example of a database device for holding latest database 6a including destination information for all users who use the network, that is, destination information such as “destination names (user names)”, “facsimile numbers” and “electronic mail addresses” which indicate destinations of the facsimile transmission as shown in FIG. 2. The LDAP server 6 has a function to search the destination information in the database 6a with search keys such as the name of destination or the facsimile number under the condition of match full. The latest database indicates the database which is to be renewed to the latest content, and the frequency of renewal is determined on case-by-case basis.

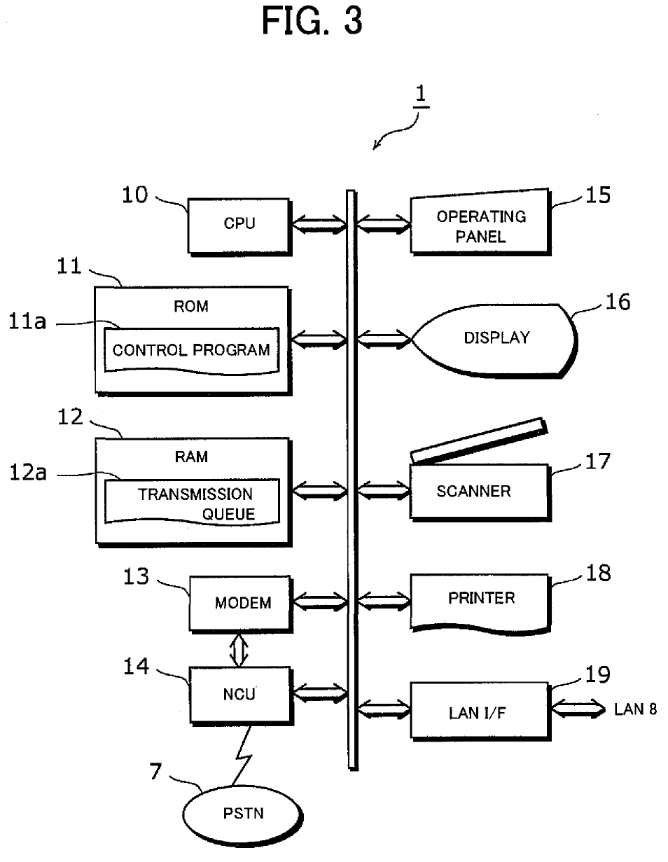

The facsimile machine 1 is an example of the facsimile machine according to the present invention and is characterized in that various functions for preventing erroneous transmission are provided as described later. The facsimile machine 1 is, for example, Multi Function Peripherals (MFP) having a function as a Web server, and includes a Central Processing Unit (CPU) 10, a Read Only Memory (ROM) 11, a Random Access Memory (RAM) 12, a modem 13, a Network Control Unit (NCU) 14, an operating panel 15, a display 16, a scanner 17, a printer 18 and a LAN inter face (LAN I/F) 19 as a hardware configuration as illustrated in FIG. 3.

The CPU 10 is a processor for executing the control program 11a stored in the ROM 11, such as one-chip micro computer having a calender/timer and so on integrated therein.

The ROM 11 is a read only memory having a control program 11a, and so on.

The RAM 12 is a readable and writable memory having a work area used by the CPU 10 for executing the control program 11a, a volatile storage area for temporarily holding image data read by the scanner 17 or image data or the like sent from the opposite facsimile machine 2, and a non-volatile storage area for holding a transmission queue 12a as a transmission buffer.

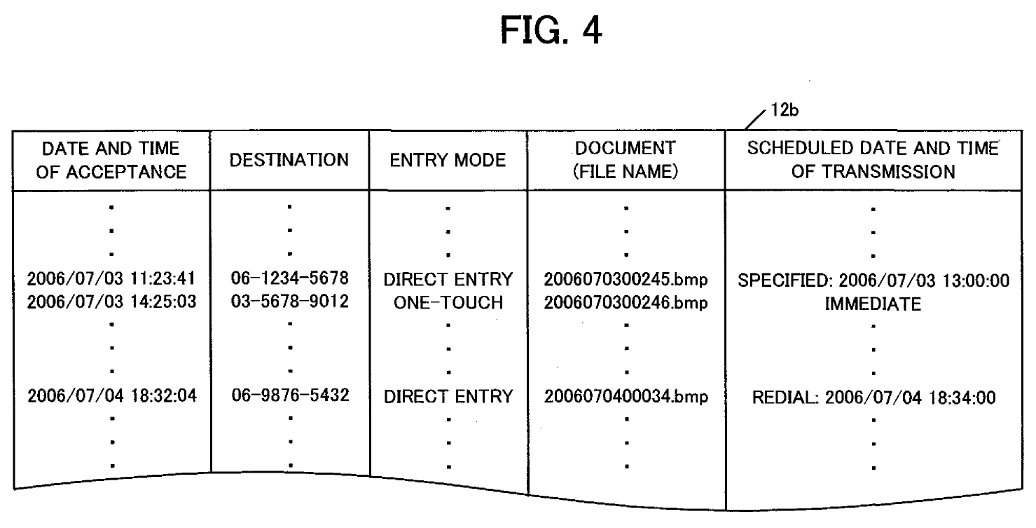

The transmission queue 12a is a storage buffer for holding documents for the time-specified facsimile transmission or the redialing facsimile transmission (waiting documents). The transmission queue 12a includes a management table 12b for managing the documents held in the transmission queue 12a stored therein. Here, the control table 12b includes entries corresponding to the respective documents held in the transmission queue 12a such as “date and time of acceptance” indicating the date and time when the transmission instruction is accepted, the “destination” indicating the destination of transmission, “entry mode” indicating a method of specifying the destination of transmission, “document (file name)” indicating the data name of the document to be transmitted (or the place of storage in the RAM 12) and “scheduled date and time of transmission” indicating the timing of transmission as illustrated in FIG. 4.

In the “entry mode” in the management table 12b, “direct entry” means that the facsimile number is directly entered by numeral keys, and “one-touch” means that the facsimile number which is registered in advance is entered by pressing a one-touch button or a speed dial. In the “scheduled transmission date and time”, “immediate” means to execute transmission without time lag according to the order of transmission instruction (the order of registration to the transmission queue 12a), and “specified: year/month/date and time” means that the transmission is to be executed at the specified date and time, and “redial: year/month/date and time” means that the retransmission is to be executed by redialing at the date and time after a certain period of time has elapsed from the date and time when the transmission is attempted for the previous time which has failed.

The modern 13 is a facsimile modem for modulating image data for the facsimile transmission and demodulating image data transmitted from the outside through facsimile.

The NCU 14 is a line terminating device to be connected to the PSTN 7.

The operating panel 15 is a panel for accepting the operation from the user, such as numerical keys for entering the destination of the facsimile transmission directly or entering the speed dial, a key for the one-touch transmission and a touch panel for pressing soft buttons appeared on the display 16.

The display 16 is a liquid crystal display device (LCD), and is used for dialogue with the user or displays the operating state of the facsimile machine 1.

The scanner 17 is a image reading device that reads the content of the document to be transmitted by facsimile or to be copied and printed by the printer 18 via a Charge-Coupled Device (CCD), and generates image data to be accumulated in the transmission queue 12a.

The printer 18 is a printing device for printing and outputting image data, for example, transmitted from the opposite facsimile machine 2 (facsimile receiving data), content read by the scanner 17 or the operating state of the facsimile machine 1.

The LAN I/F 19 is a communication adapter for connecting the facsimile machine 1 and the LAN 8.

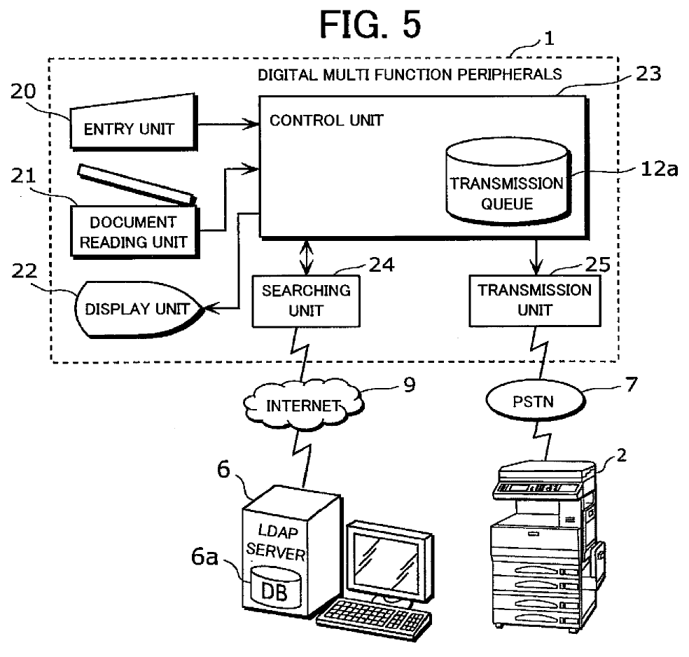

FIG. 5 is a block diagram illustrating a characteristic functional configuration of the facsimile machine 1 according to the present invention. That is, it is a block diagram illustrating the function according to the present invention from among the functions of the facsimile machine 1 exhibited by the hardware configuration illustrated in FIG. 3.

The facsimile machine 1 functionally includes an entry unit 20, a document reading unit 21, an output unit 22, a control unit 23, a searching unit 24 and a transmitting unit 25.

The entry unit 20 corresponds to a function as a Web server that receives various instructions from the operating panel 15 or Web clients (terminal devices 3 and 4) in FIG. 3, and accepts the transmission instruction including the destination of the facsimile transmission or instructions relating to various setting parameters such as “collating mode”. The term “collating model” is one of the setting parameters for specifying whether or not the collation between the destination and the database 6a is to be executed when the facsimile number is directly entered as the destination of the facsimile transmission, and the value is stored in RAM 12. When the “collating mode” is set to “ON”, the destination is collated with the database 6a when the facsimile number is entered and at the time of time-specified transmission and the redialing transmission, and the facsimile transmission is executed only when the destination information including the destination exists in the database 6a.

The document reading unit 21 corresponds to the scanner 17 in FIG. 3, and is a processing unit for acquiring a document to be transmitted by facsimile. The document acquired by the document reading unit 21 is accumulated in the transmission queue 12a in the control unit 23 once, and is transmitted by the transmitting unit 25 immediately or at a specified time.

The output unit 22 is a processing unit which is realized mainly by the CPU 10, the control program 11a and the display 16 or the printer 18 in FIG. 3, and notifies the operator the fact that the destination does not exist when the destination specified as the destination of transmission does not exit in the database 6a.

The searching unit 24 is a processing unit realized mainly by the CPU 10, the control program 11a and the LAN I/F 19 in FIG. 3, and is an example of searching means that searches the destination information in the database 6a that the LDAP server 6 holds with the destination accepted by the entry unit 20 as a search key.

The transmitting unit 25 is a processing unit realized mainly by the CPU 10, the control program 11a, the modem 13, and the NCU 14 in FIG. 3, and is an example of transmission means that executes the facsimile transmission.

The control unit 23 is a processing unit realized mainly by the CPU 10 the control program 11a and the like in FIG. 3, and is an example of control means that controls to cause the searching unit 24 to execute search for the first time immediately after the acceptance of the transmission instruction by the entry unit 20, and for the second time immediately before the facsimile transmission in the case in which the entry unit 20 accepts the time-specified transmission instruction, or immediately before the facsimile transmission by redialing, and cause the transmitting unit 25 to execute the facsimile transmission to a corresponding destination when it is found that the destination information including the search key exists in the database by the searches for the first time and the second time.

The control unit 23 determines whether or not the time period from the acceptance of the transmission instruction by the entry unit 20 until the time-specified facsimile transmission or the redialing facsimile transmission is executed by the transmitting unit 25 is longer than a predetermined time period and, if not, causes the transmitting unit 25 to execute the time-specified facsimile transmission or the redialing facsimile transmission without causing the search for the second time to be executed. More specifically, the control unit 23 determines whether or not the date that the entry unit 20 accepts the transmission instruction matches the date when the transmitting unit 25 executes the time-specified facsimile transmission or the redialing facsimile transmission and, if yes, causes the transmitting unit 25 to execute the time-specified facsimile transmission or the redialing facsimile transmission without executing the search for the second time.

When the entry unit 20 accepts the instruction not to collate the destination and the database (when the “collating model” is set to “OFF”), the control unit 23 causes the transmitting unit 25 to execute the time-specified facsimile transmission or the redialing facsimile transmission without executing the searches for the first time and the second time. When the control unit 23 includes the transmission queue 12a for holding documents for the time-specified transmission and the redialing facsimile transmission, and it is found that the destination information including the search key exists in the database by the search for the first time and that the destination information including the search key does not exist in the database by the search for the second time, the control unit 23 notifies the operator the fact that a corresponding destination does not exist via the output unit 22, and deletes the document stored in the transmission queue 12a and the corresponding entry in the management table 12b or brings the corresponding entry in the management table 12b to be held in the editable state.

Subsequently, the operation of the facsimile machine 1 according to this embodiment configured as described above will be described.

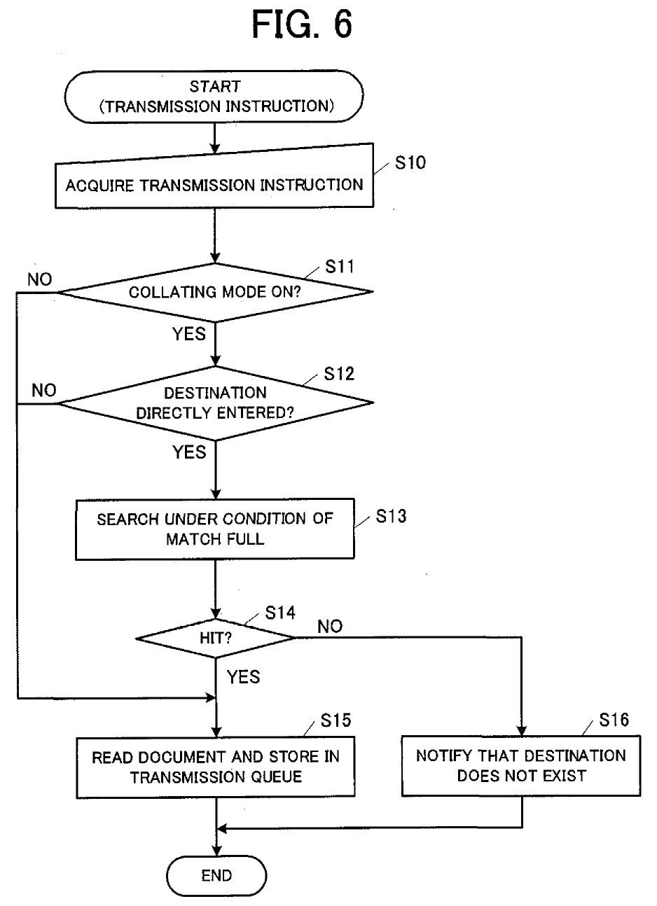

FIG. 6 is a flowchart showing a procedure of processing of the facsimile machine 1 when the operator issues an instruction of the facsimile transmission.

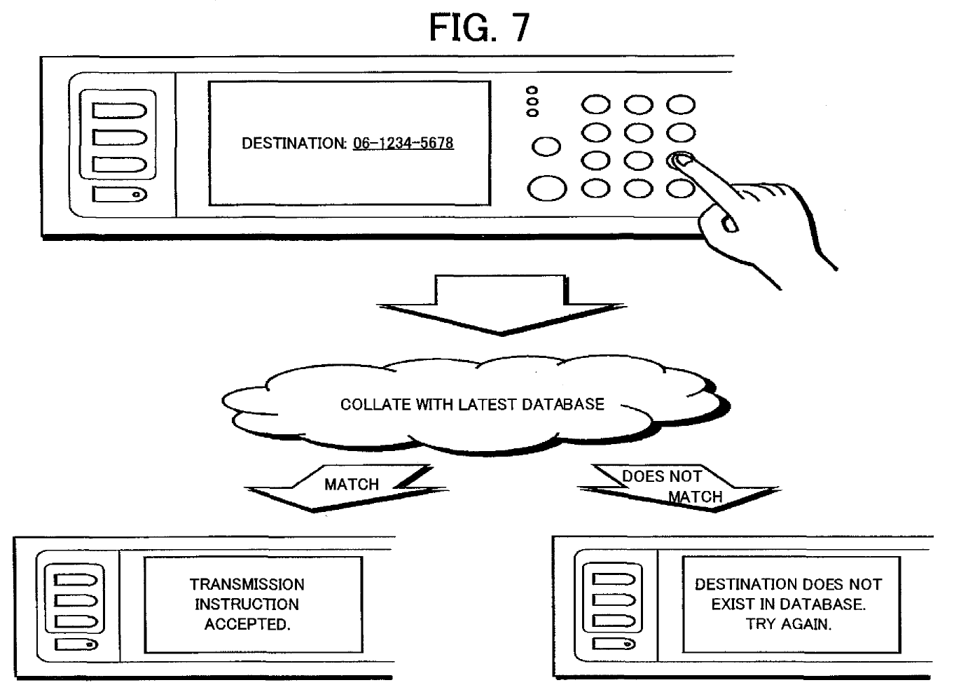

The entry unit 20 accepts the transmission instruction including the destination of the facsimile transmission from the operator as an example of operation illustrated in the upper part of FIG. 7 (S10)

Subsequently, the control unit 23 references the “collating mode” set in advance and, when the “collating mode” is set to “OFF” (No in S11), activates the original reading unit 21 to causes the same to read the document and stores the read document in the transmission queue 12a, as well as registers one entry in the management table 12b illustrated in FIG. 4 (S15).

In contrast, when the “collating mode” is set to “ON” (Yes in S11), the control unit 23 subsequently determines whether or not the destination is specified by the direct entry (S12) and if not (entry by one-touch key or the like) (No in S12), it is determined that the possibility that the destination is entered erroneously is low, and hence causes the document reading unit 21 to read the document, and then the read document is registered to the transmission queue 12a (S15).

In contrast, when the destination is specified by the direct entry (Yes in S12), the control unit 23 determines that the possibility that the destination is erroneously entered is high, and causes the searching unit 24 to execute the search for the corresponding destination (S13). That is, the searching unit 24 searches the destination information in the database 6a held by the LDAP server 6 with the destination as a search key under the condition of match full under the control of the control unit 23, and reports the search result to the control unit 23.

Consequently, when the destination information including the search key exists in the database 6a (Yes in S14), the control unit 23 determines that the destination is correct, and causes the document reading unit 21 to read the document and stores the read document in the transmission queue 12a, registers the transmission information in the management table 12b (S15), and notifies the operator the fact that the transmission instruction is accepted via the output unit 22 as an example of display illustrated in the lower left part of FIG. 7.

In contrast, when the destination information including the search key does not exist in the database 6a (No in S14), the control unit 23 notifies the operator the fact that the corresponding destination does not exist via the output unit 22 as in an example of display illustrated in the lower right part of FIG. 7.

In this manner, when the operator enters the facsimile number directly to give the transmission instruction, it is determined whether or not the facsimile number exists in the latest database 6a. Only when it exists, the document is stored in the transmission queue 12a as the object to be transmitted by facsimile. Therefore, when the facsimile number which is not registered in the latest database 6a is entered by the wrong input, the transmission is rejected, and hence the erroneous transmission is avoided.

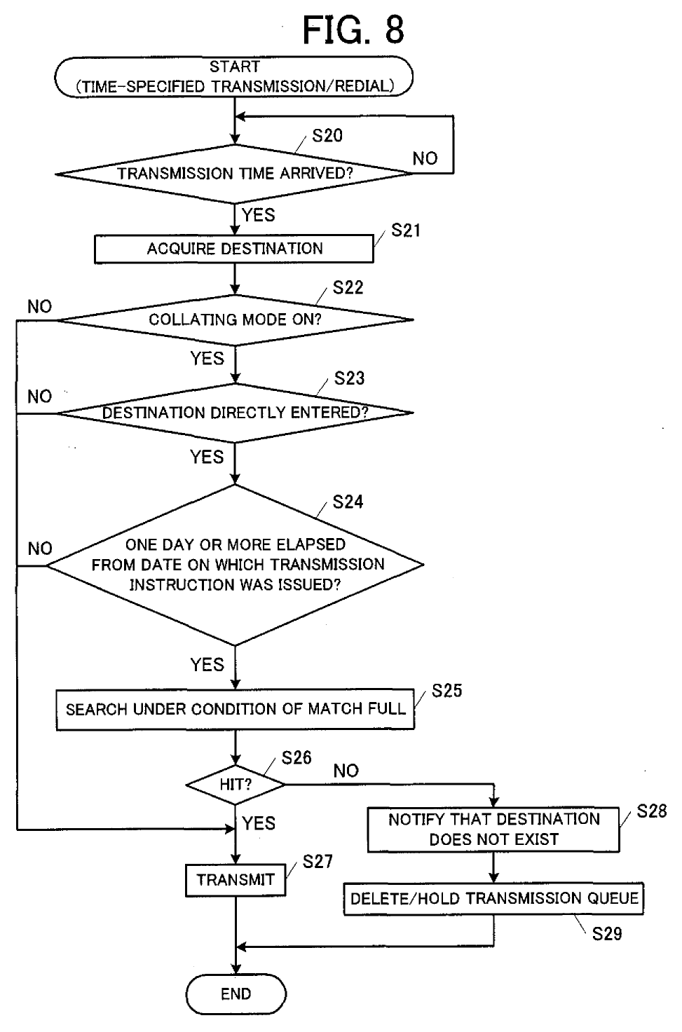

FIG. 8 is a drawing showing a procedure of processing of the facsimile machine 1 when reading the document accumulated in the transmission queue 12a and executing the time-specified facsimile transmission or the redialing facsimile transmission.

In the first place, the control unit 23 collates the current date and time indicated by the calender/timer integrated therein and the “scheduled date and time of transmission” in the management table 12b in the transmission queue 12a to extract the document which reaches the time of transmission from among the documents accumulated in the transmission queue 12a (S20).

When the document which reaches the time of transmission is found (Yes in S20), the control unit 23 acquires the destination by reading the “destination” in the management table 12b in the transmission queue 12a (S21).

Then, the control unit 23 references the preset “collating mode” and, when the “collating mode” is set to “OFF” (No in S22), reads out the document that reaches the corresponding time is read from the transmission queue 12a, and causes the same to execute the facsimile transmission by sending the read document and the “destination” information to the transmitting unit 25 (S27).

In contrast, when the “collating mode” is set to “ON” (Yes in S22), the control unit 23 reads the “entry mode” in the management table 12b subsequently, determines whether or not the read “entry mode” is “direct entry” (S23) and, if it is not the “direct entry” (entry by the one-touch key or the like”) (No in S23), it is determined that the possibility that the destination is erroneously entered is low, reads the document that reaches the time of transmission from the transmission queue 12a and sends the read document and the “destination” information to the transmitting unit 25 to causes the same to execute the facsimile transmission (S27).

In contrast, when the “input mode” is “direct entry” (Yes in S23), the control unit 23 reads the “accepted date and time” in the management table 12b subsequently, and compares the “date and time of acceptance” with the current date and time indicated by the calender/timer to determine whether or not one day or more has elapsed from the date on which the transmission instruction was issued, that is, whether or not the day when the transmission instruction is accepted is different from the day when the time-specified facsimile transmission or the redialing facsimile transmission (S24).

As a consequence, when one day or more has not elapsed (No in S24), the control unit 23 determines that the reconfirmation of the destination is not necessary, reads the document which reaches the time of transmission from the transmission queue 12a, and sends the read document and the “destination” information to the transmitting unit 25 to causes the same to execute the facsimile transmission (S27). The reason why it is determined that the reconfirmation is not necessary is because the frequency of renewal of the database 6a once a day in this embodiment and the destination is already collated with the database 6a in the same day (when the transmission instruction is issued).

In contrast, when one or more days have elapsed from the date on which the transmission instruction was issued (Yes in S24), the control unit 23 determines that the possibility that the destination is erroneously entered is high, and causes the searching unit 24 to execute search for the corresponding destination (S25). That is, the searching unit 24 searches the destination information in the database 6a held by the LDAP server 6 with the destination as a search key under the condition of match full under the control of the control unit 23, and reports the search result to the control unit 23.

Consequently, when the destination information including the search key exists in the database 6a (Yes in S26) the control unit 23 determines that the destination is correct, reads the document which reaches the time of transmission from the transmission queue 12a and sends the read document and the “destination” information to the transmitting unit 25 to causes the same to execute the facsimile transmission (S27).

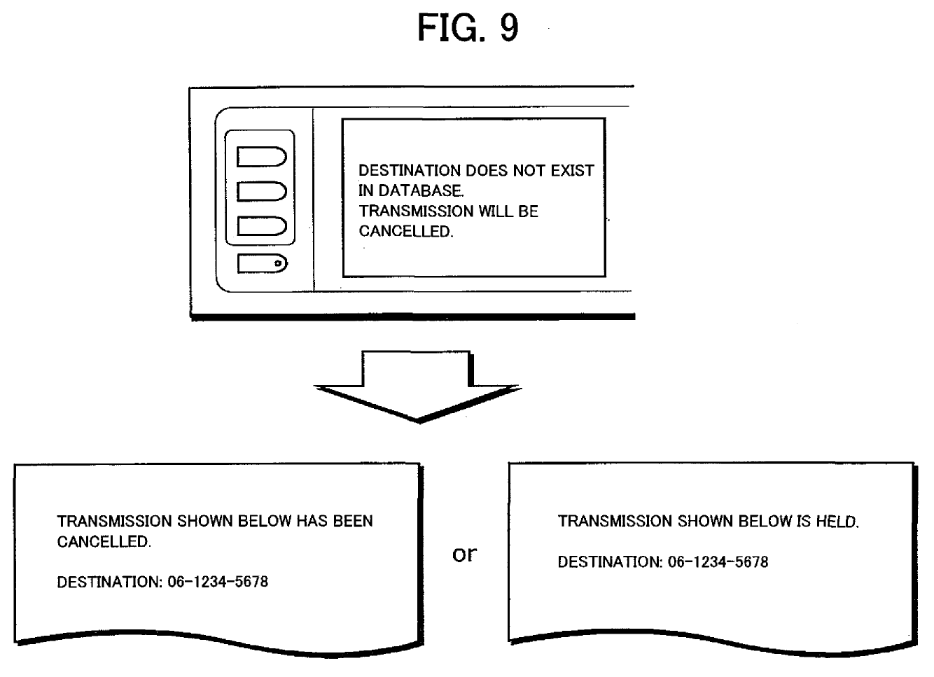

In contrast, when the destination information including the search key does not exist in the database 6a (No in S26), the control unit 23 causes the output unit 22 to display that the corresponding destination does not exist in the database 6a (S28) deletes the document stored in the transmission queue 12a and the corresponding entry in the management table 12b or brings the corresponding entry in the management table 12b to be held in the editable state (S29) and causes the output unit 22 to print out the content that indicates that interest as a print example illustrated in the lower part of FIG. 9. When the management table 12b is brought into the “held state”, the operator may access the corresponding entry in the management table 12b via the entry unit 20 for editing such as to change the “destination” into the correct information.

In this manner, when the facsimile number of the destination is entered directly in a state in which the “collating mode” is “ON”, and one day or more has elapsed from the time when the transmission instruction was issued until the time when it is transmitted, whether or not the destination exists in the latest database 6a not only at the time when the transmission instruction is issued, but also immediately before the transmission, and the transmission is executed only when it exists. Therefore, even when the destination is changed for the reason such that the facsimile number of the opposite side is changed during the period from the time when the transmission instruction is issued to when the transmission is executed, it is detected and hence the transmission is cancelled, so that the erroneous transmission is avoided.

Although the facsimile machine according to the present invention has been described on the basis of the embodiment, the present invention is not limited thereto.

For example, in this embodiment, confirmation of the destination is achieved by determining whether or not the facsimile number entered directly exists in the database 6a. However, the present invention is not limited thereto. When any one of, or a combination of two or more of the name of the destination, the facsimile number and the electronic mail address is specified as the destination, it is also possible to configure so as to determine that the destination exists in the database 6a on the basis of match full or when at least one of them matches (match partial). Accordingly, the strictness of the criteria of the destination collation may be adjusted.

In this embodiment, the LDAP server 6 is used as the database device for holding the latest database including the destination information collected therein. However, the present invention is not limited to the device in which the protocol is mounted, and any database device may be employed as long as it is a device which holds at least the latest facsimile number.

In this embodiment, the object of the confirmation of the destination immediately before transmission is only the case in which the facsimile number is entered directly and one day or more has elapsed from the time when the transmission instruction is issued until the time when the transmission is executed. However, the present invention is not limited to such condition. For example, it is also possible to always execute the destination confirmation immediately before transmission irrespective of the “entry mode” of the destination in the transmission instruction. It is because the erroneous transmission due to the change of the facsimile number is avoided more reliably. In the same manner, it is also possible to always execute the confirmation of the destination immediately before transmission irrespective of the number of date (time) elapsed from the transmission instruction to the transmission. It is because the erroneous transmission due to the change of the facsimile number is avoided reliably without depending on the frequency of renewal of the database 6a.

The present invention may be used as a facsimile machine, for example, as an MFP, and more specifically, as an facsimile machine in which the erroneous transmission caused by the change of the facsimile number of the opposite party is presented.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A facsimile machine comprising:
a connecting unit to which an external database device is connected via communication networks;
an entry unit that accepts transmission instruction including the destination of facsimile transmission;
a searching unit that searches a destination information in a database held by the database device with the destination accepted by the entry unit as a search key;
a transmitting unit that executes the facsimile transmission; and
a control unit that causes the searching unit to execute a search for the first time immediately after the acceptance of the transmission instruction by the entry unit and for the second time immediately before the facsimile transmission in the case in which the entry unit accepts the time-specified transmission instruction and, when it is found that the destination information including the search key exists in the database by the searches for the first time and the second time, causes the transmitting unit to execute the facsimile transmission for the corresponding destination.

2. The facsimile machine according to claim 1, wherein the control unit further determines whether or not the time period from the acceptance of the transmission instruction by the entry unit until the time-specified facsimile transmission is executed by the transmitting unit is longer than a predetermined time period and, if not, causes the transmitting unit to execute the time-specified facsimile transmission without causing the search for the second time to be executed.

3. The facsimile machine according to claim 2, wherein the control unit determines whether or not the date when the transmission instruction is accepted by the entry unit matches the date when the transmission unit executes the time-specified facsimile transmission and, if yes, causes the transmission unit to execute the time-specified facsimile transmission without causing the search for the second time to be executed.

4. The facsimile machine according to claim 1, wherein the entry unit further accepts an instruction indicating whether or not the destination is to be collated with the database and, when the entry unit accepts the instruction not to collate the destination and the database, the control unit causes the transmitting unit to execute the time-specified facsimile transmission without causing the searches to be executed for the first time and the second time.

5. The facsimile machine according to claim 1, wherein the control unit includes a transmission queue for holding documents for the time-specified facsimile transmission, and wherein the control unit notifies the fact that the corresponding destination does not exist, and deletes the document for the corresponding destination in the transmission queue or brings the corresponding destination in a held state so that the destination is editable when it is found that the destination information including the search key exists in the database by the search for the first time and that the destination information including the search key does not exist in the database by the search for the second time.

6. A facsimile machine comprising:
a connecting unit to which an external database device is connected via communication networks;
an entry unit that accepts transmission instruction including the destination of facsimile transmission;
a searching unit that searches a destination information in a database held by the database device with the destination accepted by the entry unit as a search key;
a transmitting unit that executes the facsimile transmission; and
a control unit that causes the searching unit to execute search for the first time immediately after the acceptance of the transmission instruction by the entry unit and for the second time immediately before redialing facsimile transmission and, when it is found that the destination information including the search key exists in the database by the searches for the first time and the second time, causes the transmitting unit to execute the facsimile transmission for the corresponding destination.

7. The facsimile machine according to claim 6, wherein the control unit further determines whether or not the time period from the acceptance of the transmission instruction by the entry unit until the redialing facsimile transmission is executed by the transmitting unit is longer than a predetermined time period and, if not, causes the transmitting unit to execute the redialing facsimile transmission without causing the search for the second time to be executed.

8. The facsimile machine according to claim 7, wherein the control unit determines whether or not the date when the transmission instruction is accepted by the entry unit matches the date when the transmission unit execute the redialing facsimile transmission and, if yes, causes the transmitting unit to execute the redialing facsimile transmission to execute the redialing facsimile transmission without causing the search for the second time to be executed.

9. The facsimile machine according to claim 6, wherein the entry unit further accepts an instruction indicating whether or not the destination is to be collated with the database and, when the entry unit accepts the instruction not to collate the destination and the database, the control unit causes the transmitting unit to execute the redialing facsimile transmission without executing the searches for the first time and the second time.

10. The facsimile machine according to claim 6, wherein the control unit includes a transmission queue for holding documents for the redialing facsimile transmission, and wherein the control unit notifies the fact that the corresponding destination does not exist, and deletes the document for the corresponding destination in the transmission queue or brings the corresponding destination in a held state so that the destination is editable when it is found that the destination information including the search key exists in the database by the search for the first time and that the destination information including the search key does not exist in the database by the search for the second time.

11. A facsimile communication method comprising:
an entering step for accepting transmission instruction including the destination of facsimile transmission;
a searching step for searching a destination information in a database held by a database device with the destination accepted in the entering step as a search key for the first time immediately after the acceptance of the transmission instruction in the entering step and for the second time immediately before the facsimile transmission in the case in which the time-specified transmission instruction is accepted in the entering step; and
a transmitting step for executing the facsimile transmission for the corresponding destination when it is found that the destination information including the search key exists in the database by the searches for the first time and the second time.

12. The facsimile communication method according to claim 11,
wherein in the transmitting step, whether or not the time period from the acceptance of the transmission instruction in the entering step until the time-specified facsimile transmission is executed is longer than a predetermined time period is determined and, if not, the time-specified facsimile transmission is executed without executing the search for the second time in the searching step.

13. The facsimile communication method according to claim 12, wherein in the transmitting step, whether or not the date when the transmission instruction is accepted in the entering step matches the date when the time-specified facsimile transmission is executed is determined and, if yes, the time-specified facsimile transmission is executed without executing the search for the second time in the searching step.

14. The facsimile communication method according to claim 11, wherein in the entering step, an instruction indicating whether or not the destination is to be collated with the database is further accepted and,
wherein in the transmitting step, the time-specified facsimile transmission is executed without executing the searches for the first time and the second time when the instruction not to collate the destination and the database is accepted in the entering step.

15. The facsimile communication method according to claim 11, further comprising a notifying step for notifying the fact that the corresponding destination does not exist, and deleting the document for the corresponding destination in the transmission queue or brings the corresponding destination in a held state so that the destination is editable when it is found that the destination information including the search key exists in the database by the search for the first time and that the destination information including the search key does not exist in the database by the search for the second time.

16. A facsimile communication method comprising:
an entering step for accepting transmission instruction including the destination of facsimile transmission;
a transmitting unit for executing facsimile transmission;
a searching step for searching a destination information in a database held by an external database device with the destination accepted in the entering step as a search key for the first time immediately after the acceptance of the transmission instruction in the entering step and for the second time immediately before redialing facsimile transmission; and
wherein the facsimile transmission for the corresponding destination is executed when it is found that the destination information including the search key exists in the database by the searches for the first time and the second time.

17. The facsimile communication method according to claim 16, wherein in the transmitting step, whether or not the time period from the acceptance of the transmission instruction in the entering step until the time-specified facsimile transmission is executed is longer than a predetermined time period is determined and, if not, the redialing facsimile transmission is executed without executing the search for the second time in the searching step.

18. The facsimile communication method according to claim 17, wherein in the transmitting step, whether or not the date when the transmission instruction is accepted in the entering step matches the date when the redialing facsimile transmission is executed is determined and, if yes, the redialing facsimile transmission is executed without executing the search for the second time.

19. The facsimile communication method according to claim 16, wherein in the entering step, an instruction indicating whether or not the destination is to be collated with the database is further accepted, and
wherein in the transmitting step, the redialing facsimile transmission is executed without executing the searches for the first time and the second time in the searching step when the instruction not to collate the destination and the database is accepted.

20. The facsimile communication method according to claim 16, further comprising a notifying step for notifying the fact that the corresponding destination does not exist, and deleting the document for the corresponding destination in the transmission queue or bringing the corresponding destination in a held state so that the destination is editable when it is found that the destination information including the search key exists in the database by the search for the first time and that the destination information including the search key does not exist in the database by the search for the second time.
